(19) United States
(12) Patent Application Publication
(10) Pub. No.: US 2026/0212465 A1
(43) Pub. Date: Jul. 23, 2026

(54) NONLINEAR UNSHARP MASKING FOR HALO-CONTROLLED IMAGE SHARPENING

(71) Applicant: Samsung Electronics Co., Ltd., Suwon-si (KR)

(72) Inventors: Abhinau K. Venkataramanan, Plano, TX (US); Hamid R. Sheikh, Allen, TX (US)

(21) Appl. No.: 19/213,793

(22) Filed: May 20, 2025

Related U.S. Application Data
(60) Provisional application No. 63/746,742, filed on Jan. 17, 2025.

(51) Int. Cl. G06T 5/75; G06V 10/26; G06V 10/764

(52) U.S. Cl. CPC G06T 5/75; G06V 10/26; G06V 10/764; G06T 2207/10024; G06T 2207/20192

(57) ABSTRACT

A method includes obtaining a first channel of an input image and generating an unsharp mask based on the first channel of the input image. The method also includes applying a nonlinear function to pixels of the unsharp mask to obtain a modulated unsharp mask. The method further includes combining the first channel of the input image and the modulated unsharp mask to obtain a first channel of an output image. The method also includes sharpening one or more remaining channels of the input image based on the unsharp mask to obtain one or more remaining channels of the output image. In addition, the method includes combining the first channel of the output image and the one or more remaining channels of the output image to generate the output image.

### CROSS-REFERENCE TO RELATED APPLICATION AND CLAIM OF PRIORITY

This application claims priority under 35 U.S.C. § 119(e) to U.S. Provisional Patent Application No 63/746,742 filed on Jan. 17, 2025, which is hereby incorporated by reference in its entirety.

### TECHNICAL FIELD

This disclosure relates generally to image sharpening. More specifically, this disclosure relates to nonlinear unsharp masking for halo-controlled image sharpening.

### BACKGROUND

Image sharpening is a common enhancement operation performed in camera software pipelines to increase the visibility of textures and details and is a significant step in image processing and image restoration tasks. One goal of image sharpening is to increase the visibility of edges and details in images in order to improve the overall feeling of sharpness in the images. This is typically achieved by filtering an input image using a high pass filter to obtain an edge map and adding the result back to the input image, thereby enhancing edges.

### SUMMARY

This disclosure relates to nonlinear unsharp masking for halo-controlled image sharpening.

In a first embodiment, a method includes obtaining, using at least one processing device of an electronic device, a first channel of an input image. The method also includes generating, using the at least one processing device, an unsharp mask based on the first channel of the input image. The method further includes applying, using the at least one processing device, a nonlinear function to pixels of the unsharp mask to obtain a modulated unsharp mask. The method also includes combining, using the at least one processing device, the first channel of the input image and the modulated unsharp mask to obtain a first channel of an output image. The method further includes sharpening, using the at least one processing device, one or more remaining channels of the input image based on the unsharp mask to obtain one or more remaining channels of the output image. In addition, the method includes combining, using the at least one processing device, the first channel of the output image and the one or more remaining channels of the output image to generate the output image.

In a second embodiment, an electronic device includes at least one processing device configured to obtain a first channel of an input image and generate an unsharp mask based on the first channel of the input image. The at least one processing device is also configured to apply a nonlinear function to pixels of the unsharp mask to obtain a modulated unsharp mask. The at least one processing device is further configured to combine the first channel of the input image and the modulated unsharp mask to obtain a first channel of an output image. The at least one processing device is also configured to sharpen one or more remaining channels of the input image based on the unsharp mask to obtain one or more remaining channels of the output image. In addition, the at least one processing device is configured to combine the first channel of the output image and the one or more remaining channels of the output image to generate the output image.

In a third embodiment, a non-transitory machine readable medium contains instructions that when executed cause at least one processor of an electronic device to obtain a first channel of an input image and generate an unsharp mask based on the first channel of the input image. The non-transitory machine readable medium also contains instructions that when executed cause the at least one processor to apply a nonlinear function to pixels of the unsharp mask to obtain a modulated unsharp mask. The non-transitory machine readable medium further contains instructions that when executed cause the at least one processor to combine the first channel of the input image and the modulated unsharp mask to obtain a first channel of an output image. The non-transitory machine readable medium also contains instructions that when executed cause the at least one processor to sharpen one or more remaining channels of the input image based on the unsharp mask to obtain one or more remaining channels of the output image. In addition, the non-transitory machine readable medium contains instructions that when executed cause the at least one processor to combine the first channel of the output image and the one or more remaining channels of the output image to generate the output image.

Any single one or any combination of the following features may be used with the first, second, or third embodiment. The first channel of the input image may be a luma channel of the input image, and the one or more remaining channels of the input image may be chroma channels of the input image. The nonlinear function may be a function of a signed value of the unsharp mask. Based on the first channel of the input image, a first amount of enhancement may be applied with the nonlinear function to areas of the input image having at least a first value for the first channel, and a second amount of enhancement may be applied with the nonlinear function to areas of the input image having no more than a second value for the first channel (the second value may be lower than the first value to reduce edge halos during enhancement). Based on the first channel of the input image, a first amount of enhancement may be applied with the nonlinear function to areas of the input image having a first color value, and a second amount of enhancement may be applied with the nonlinear function to areas of the input image having a second color value to preserve edge color during enhancement. Semantic segmentation of the input image may be performed, a first amount of enhancement may be applied with the nonlinear function to areas of the input image having a first semantic class label, a second amount of enhancement may be applied with the nonlinear function to areas of the input image having a second semantic class label, and a third amount of enhancement may be applied with the nonlinear function to areas of the input image having a third semantic class label.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for”, “having the capacity to”, “designed to”, “adapted to”, “made to”, or “capable of” depending on the circumstances. The phrase “configured (or set) to” does not essentially mean “specifically designed in hardware to”. Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a”, “an”, and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism”, “module”, “device”, “unit”, “component”, “element”, “member”, “apparatus”, “machine”, “system”, “processor”, or “controller”, within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration that may be employed for nonlinear unsharp masking for image sharpening in accordance with this disclosure;

FIG. 2 illustrates an example process of nonlinear unsharp masking for image sharpening in accordance with this disclosure;

FIG. 3 illustrates an example image signal processing (ISP) pipeline for nonlinear unsharp masking for image sharpening in accordance with this disclosure;

FIG. 4 illustrates an example of unsharp mask image sharpening for image sharpening within the ISP of FIG. 3 in accordance with this disclosure;

FIG. 5 illustrates an example nonlinear gain function that may be utilized by the nonlinear gain modulation operation in FIG. 4 in accordance with this disclosure;

FIG. 6 illustrates an example of unsharp mask image sharpening for image sharpening within the ISP of FIG. 3 with brightness-based enhancement modulation in accordance with this disclosure;

FIGS. 7A and 7B illustrate example nonlinear gain functions utilized by the nonlinear gain modulation operation in FIG. 6 in accordance with this disclosure;

FIG. 8 illustrates an example of unsharp mask image sharpening for image sharpening within the ISP of FIG. 3 with color-based enhancement modulation in accordance with this disclosure;

FIG. 9 illustrates an example nonlinear gain function utilized by the nonlinear gain modulation operation in FIG. 8 in accordance with this disclosure;

FIG. 10 illustrates an example of unsharp mask image sharpening for image sharpening within the ISP of FIG. 3 with semantic information-based enhancement modulation in accordance with this disclosure;

FIG. 11 illustrates an example nonlinear gain function utilized by the nonlinear gain modulation operation in FIG. 10 in accordance with this disclosure;

FIGS. 12A and 12B illustrate an example of improved image sharpening within an indicated region in accordance with this disclosure;

FIGS. 13A and 13B illustrate an example of improved halo control within an indicated region in accordance with this disclosure; and

FIGS. 14A and 14B illustrate an example of improved edge color preservation within an indicated region in accordance with this disclosure.

### DETAILED DESCRIPTION

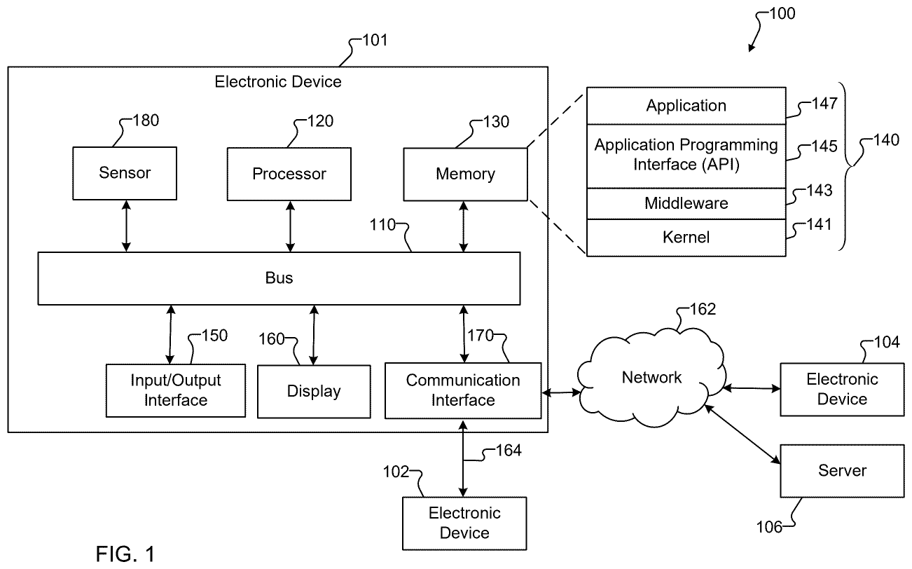

FIGS. 1 through 14B, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, image sharpening is a common enhancement operation performed in camera software pipelines to increase the visibility of textures and details and is a significant step in image processing and image restoration tasks. One goal of image sharpening is to increase the visibility of edges and details in images in order to improve the overall feeling of sharpness in the images. This is typically achieved by filtering an input image using a high pass filter to obtain an edge map and adding the result back to the input image, thereby enhancing edges.

Unsharp masking (USM) uses differences between an input image and a blurred version of the input image to create an “unsharp mask” that contains edges. The unsharp mask is multiplied by a gain, which controls the amount of sharpening, and added back to the input image. While this can be effective, one limitation of USM is that this approach can lead to strong halos, particularly around strong edges, and noise enhancement in smooth areas. In addition, USM can lead to a perceived loss of color at edges, which are pushed towards black or white.

The present disclosure describes various techniques for nonlinear unsharp masking for halo-controlled image sharpening. Among other things, these techniques can use a nonlinear enhancement gain control mechanism to control undesired artifacts, such as strong halos, during image sharpening. In some embodiments, the present disclosure introduces luma-guided chroma sharpening techniques to preserve edge colors without changing hues. Thus, techniques are presented that can be used to sharpen images without introducing significant halos around edges and without significant loss in color saturation.

FIG. 1 illustrates an example network configuration 100 that may be employed for nonlinear unsharp masking for image sharpening in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to nonlinear unsharp masking for image sharpening.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to nonlinear unsharp masking for image sharpening. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232(RS-232 ), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an augmented reality wearable device, such as eyeglasses, which include one or more imaging sensors, or a virtual reality (VR) or extended reality (XR) headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the electronic device 101 and/or the server 106 may perform various operations related to nonlinear unsharp masking for image sharpening. In some embodiments, for example, the electronic device 101 may be employed to consume content, while the server 106 may be employed to perform nonlinear unsharp masking for image sharpening for one or more images to be displayed on the electronic device 101.

Although FIG. 1 illustrates one example of a network configuration 100 including an electronic device 101 employed to perform nonlinear unsharp masking for image sharpening, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

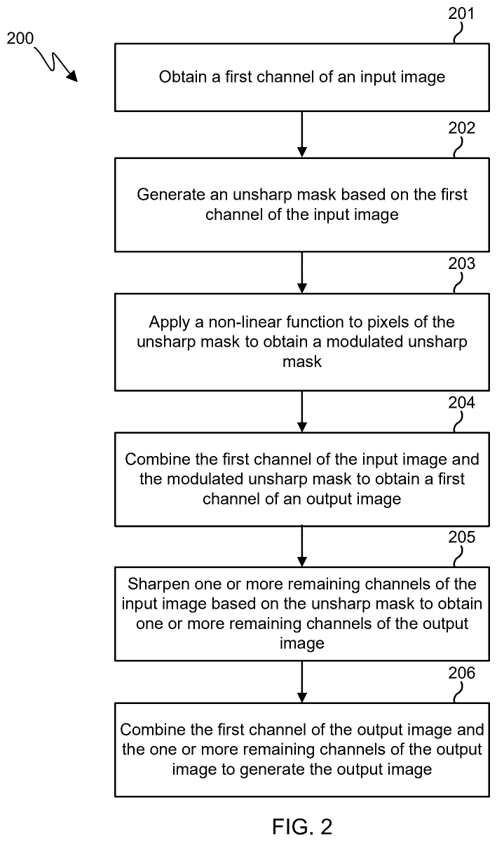

FIG. 2 illustrates an example process 200 of nonlinear unsharp masking for image sharpening in accordance with this disclosure. For ease of explanation, the process 200 of FIG. 2 is described as being performed using the server 106 in the network configuration 100 of FIG. 1. However, the process 200 may be performed using any other suitable device(s) (such as the electronic device 101) and in any other suitable system(s).

As shown in FIG. 2, the process 200 begins with obtaining a first channel of an input image (step 201). For example, this may be accomplished by extracting a luma channel from a luma-chroma input image. An unsharp mask is generated based on the first channel of the input image (step 202). For example, application of blurring (such as a Gaussian blur) may produce the unsharp mask from the luma channel of the luma-chroma input image. A nonlinear gain function is applied to pixels of the unsharp mask to obtain a modulated unsharp mask (step 203). For example, the nonlinear gain function may be based on one or more of brightness (such as the luma channel of the input image), color (such as the chroma channel of the input image), and/or semantic class (such as “face”, “text”, etc.) as well as on the unsharp mask.

The first channel of the input image and the modulated unsharp mask are combined to obtain a first channel of an output image (step 204). Here, the output image for the first channel provides benefits in halo control and edge color preservation, as well as sharpening. One or more remaining channels of the input image are sharpened based on the unsharp mask to obtain one or more remaining channels of the complete output image (step 205). In some cases, this process may be identically performed regardless of the variables used to structure the nonlinear gain function applied to the unsharp mask. The first channel of the output image and the one or more remaining channels of the output image are combined to generate the complete output image (step 206).

Although FIG. 2 illustrates one example of a process 200 of nonlinear unsharp masking for image sharpening, various changes may be made to FIG. 2. For example, while shown as a series of steps, various steps in FIG. 2 could overlap, occur in parallel, occur in a different order, or occur any number of times (including zero times).

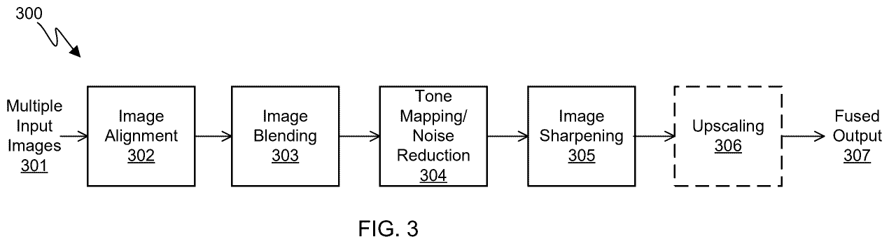

FIG. 3 illustrates an example image signal processing (ISP) pipeline 300 for nonlinear unsharp masking for image sharpening in accordance with this disclosure. For ease of explanation, the ISP pipeline 300 of FIG. 3 is described as being implemented within the server 106 in the network configuration 100 of FIG. 1, potentially operating interactively with the electronic device 101 (to which generated image content may be delivered). However, the ISP pipeline 300 may be implemented using any other suitable device(s) (such as the electronic device 101) and in any other suitable system(s).

As shown in FIG. 3, the ISP pipeline 300 depicts a general solution to image sharpening problems. Multiple input images 301, including an original input image and a blurred version of the input image, are received at image alignment 302. Image alignment 302 may be feature-based and may register features within the blurred version of the input image with corresponding features within the original input image. The output of image alignment 302 passes to image blending 303, which combines the aligned and blurred version of the input image with the original input image.

Tone mapping and/or noise reduction 304 are performed within the ISP pipeline 300, mitigating noise artifacts that may arise within the combined blurred and original input images. The output of tone mapping and/or noise reduction 304 is received by image sharpening 305, which operates as described in further detail below. The outcome of image sharpening 305 is passed to optional upscaling 306, which may resize the image (if necessary), before output of the image as a fused output 307.

Although FIG. 3 illustrates one example of an ISP pipeline for nonlinear unsharp masking for image sharpening, various changes may be made to FIG. 3. For example, while depicted as being performed sequentially, various operations in FIG. 3 may at least partially overlap or be performed in parallel. As particular examples, image blending 303 and tone mapping and/or noise reduction 304 may be performed in a pipelined manner on different regions of the received image.

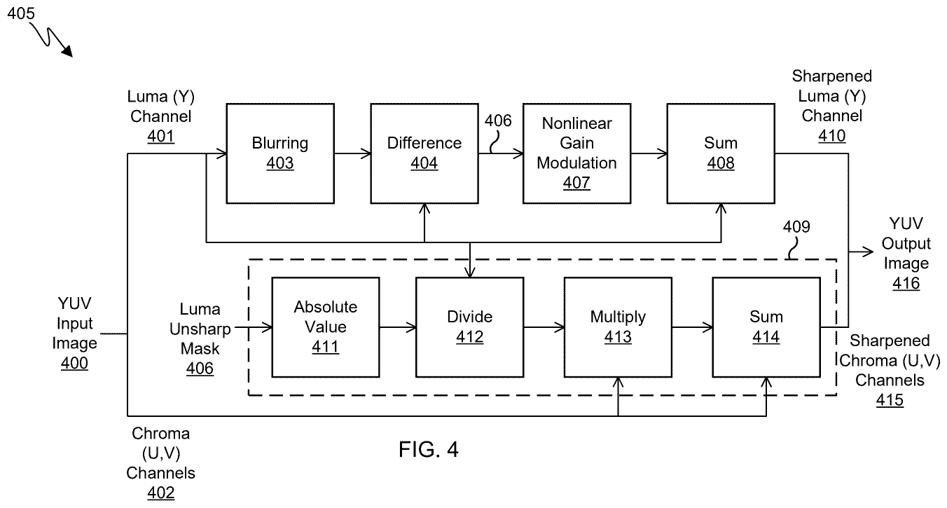

FIG. 4 illustrates an example of unsharp mask image sharpening 405 for image sharpening 305 within the ISP pipeline 300 of FIG. 3 in accordance with this disclosure. As discussed above, image sharpening can be a useful part of both HDR and SDR image processing and is also a useful part of video processing. Unsharp mask image sharpening 405 employs a nonlinear enhancement gain control mechanism to control undesired artifacts during image sharpening and uses luma-guided chroma sharpening to preserve edge colors without changing hue.

The unsharp mask image sharpening 405 obtains (such as receives) a YUV input image 400. If the received input image is not in a YUV representation (such as an RGB image instead), the image is converted to YUV, such as by using any commonly-available or other method that converts an input image of any representation into the YUV domain. Following this, the luma (Y) channel of the input image 400 is extracted to yield an input luma image 401. The remainder of the input image 400 is separately processed as an input chroma (U, V) image 402.

The input luma image 401 is received by each of a blurring operation 403, a difference operation 404, and a sum operation 408 within the pipeline for processing the input luma image 401, as well as by a divide operation 412 within the pipeline 409 for processing the input chroma image 402. Blurring operation 403 performs image blurring (such as by applying a Gaussian blur) on the input luma image 401. The input luma image 401 is subtracted from the original input luma image 401 by the difference operation 404 to generate a luma unsharp mask 406 (a/k/a Y-USM), which is passed through a nonlinear gain modulation operation 407.

In the nonlinear gain modulation operation 407, each pixel of the luma unsharp mask 406 is multiplied by a gain value that is determined based on a nonlinear function. In essence, operation 212 provides an adaptive gain enhancement to the luma unsharp mask 406 (such as a pixel gain adapted based on a pixel value). The result of the nonlinear gain modulation operation 407 is an adaptively-enhanced luma unsharp mask, which is added back to the input luma image 401 in summing operation 408 to yield a sharpened output luma image 410 (a/k/a Y-sharp channel).

The nonlinear function used in the nonlinear gain modulation operation 407 can be designed according to one or more desired design objectives. For example, one design may utilize a function having higher values in textured regions to enhance textures and lower values in strong edge regions to suppress halos. In general, the nonlinear function used in the nonlinear gain modulation operation 407 serves to modulate the enhancement gain applied to the luma unsharp mask 406. The enhancement gain is a function of the signed value of the unsharp mask, which can be used to distinguish between strong and weak edges. The sign of the unsharp mask may be used to control bright and dark halos separately. Additional information, such as brightness and color, may also be used to modulate the amount of sharpening. This is in contrast to existing technologies that use a constant gain or apply additional morphology-based processing to the unsharp mask to identify potential halos.

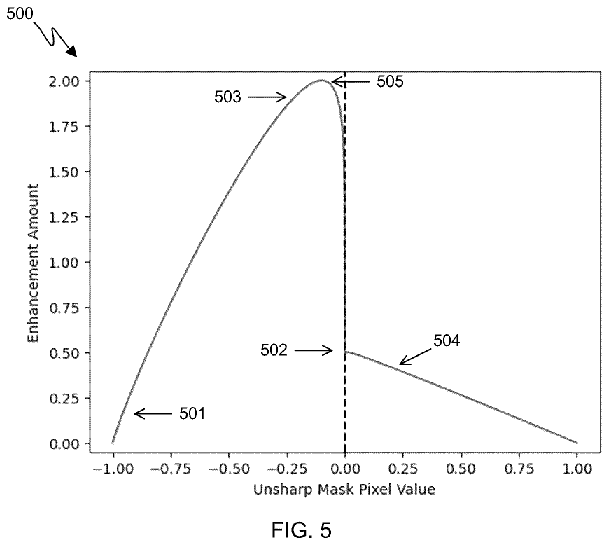

FIG. 5 illustrates an example nonlinear gain function that may be utilized by the nonlinear gain modulation operation 407 in FIG. 4 in accordance with this disclosure. As described, the output of the nonlinear gain modulation operation 407 results from application of a nonlinear function used to modulate the enhancement gain applied to the luma unsharp mask 406. The enhancement gain applied by the nonlinear gain modulation operation 407 may be a function of the signed value of the luma unsharp mask 406 and used to distinguish between strong and weak edges. The sign of the luma unsharp mask 406 may be used to control bright and dark halos separately. In the example nonlinear function of FIG. 5, different enhancement amounts 501, 502, 503 are applied depending on whether the luma unsharp mask pixel value is small (typically noise), medium (likely texture), or large (strong edge). In addition, different enhancement amounts are applied to positive luma unsharp mask pixel values 504 and to negative luma unsharp mask pixel values 505 (such as bright/dark halos). As described in further detail below, additional information, such as brightness and color, may also be used to modulate the amount of sharpening produced by the nonlinear function utilized by the nonlinear gain modulation operation 407 in FIG. 4.

Referring back to FIG. 4, the example unsharp mask image sharpening 405 uses the luma unsharp mask 406 to create a chroma enhancement mask, which is used to enhance color saturation at edges. By contrast, existing technologies either operate only on luma channels (which causes color saturation loss) or sharpen chroma channels independently (which causes hue shifts). The luma-guided chroma sharpening operations in the pipeline 409 preserves edge colors without changing hues.

The adaptive luma-guided chroma enhancement gain in the pipeline 409 is obtained for each pixel by an operation 411 that obtains the absolute value of the luma unsharp mask 406 and a divide operation 412 that divides (on a per pixel basis) the result of operation 411 by the input luma image 401. The resulting luma-guided chroma enhancement gain is used in an operation 413 to multiply both channels of the input chroma image (U, V) 402 by the adaptive chroma enhancement gain (such as output of the divide operation 412). The result of the operation 413 is added back to the input chroma image 402 (in a summing operation 414) to yield a sharpened output chroma image 415 (a/k/a U-, V-sharp channels). The sharped YUV output image 416 obtained by combining the sharpened output luma image 410 and the sharpened output chroma image 415 can be, in some instances, converted to a different color representation (such as RGB). The operations related to luma-guided chroma sharpening are in contrast to existing technologies that operate only on luma channels (which causes color saturation loss) or sharpen chroma channels independently (which causes hue shifts).

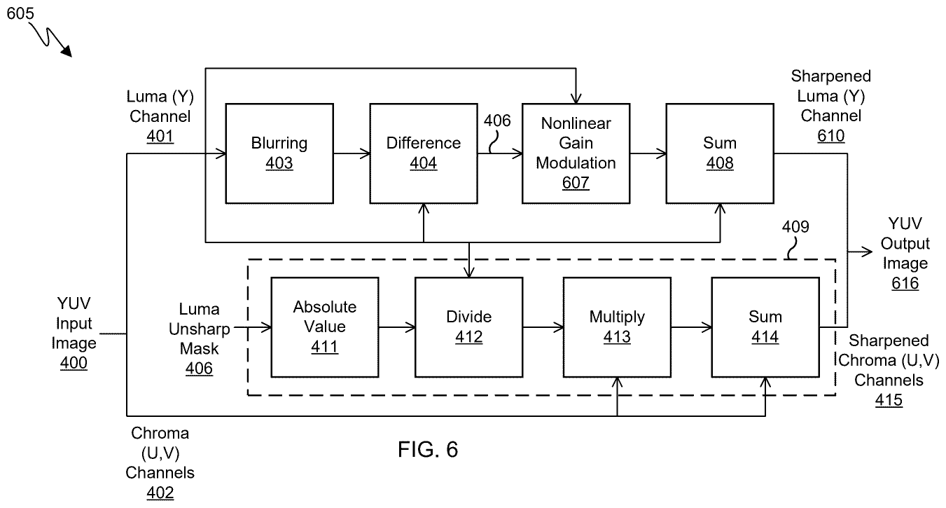

FIG. 6 illustrates an example of unsharp mask image sharpening 605 for image sharpening 305 within the ISP pipeline 300 of FIG. 3 with brightness-based enhancement modulation in accordance with this disclosure. The operations and inputs/outputs remain the same as in FIG. 4 except for the nonlinear gain modulation operation 607, the sharpened luma image 610, and the sharpened output image 616.

In this example, different enhancement amounts are applied to different areas of differing brightnesses in the input luma image 401. That is, FIG. 6 illustrates brightness-based enhancement modulation. In this implementation, the nonlinear gain function utilized by the nonlinear gain modulation operation 607 in FIG. 6 is modified to use another input, which is the Y channel of the input image 400, representing brightness. In some cases, this implementation of the nonlinear gain function may be interpreted as a two-dimensional function, where the enhancement amount is controlled both by the luma unsharp mask 406 and the brightness Y (the input luma image 401). Among other things, this enables the use of higher enhancement amounts in brighter areas (which are typically less noisy) and lower enhancement amounts in darker areas (which are typically more noisy) in addition to the above-described luma unsharp mask-based gain modulation.

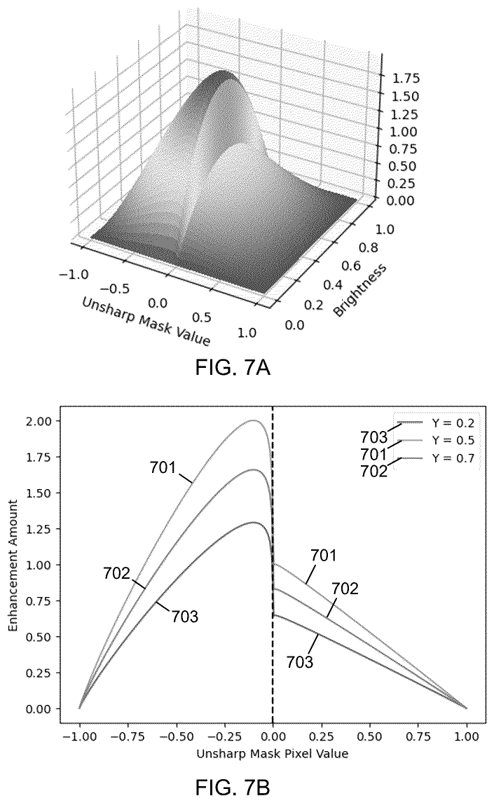

FIGS. 7A and 7B illustrate example nonlinear gain functions utilized by the nonlinear gain modulation operation 607 in FIG. 6 in accordance with this disclosure. FIG. 7A illustrates continuous enhancement modulation as functions of both the luma unsharp mask value and the brightness value. FIG. 7B illustrates quantized enhancement modulation based on the (nearest) brightness value. In FIG. 7B, gain 701 is applied when brightness Y=0.2, gain 702 is applied when brightness Y=0.5, and gain 703 is applied when brightness Y=0.7.

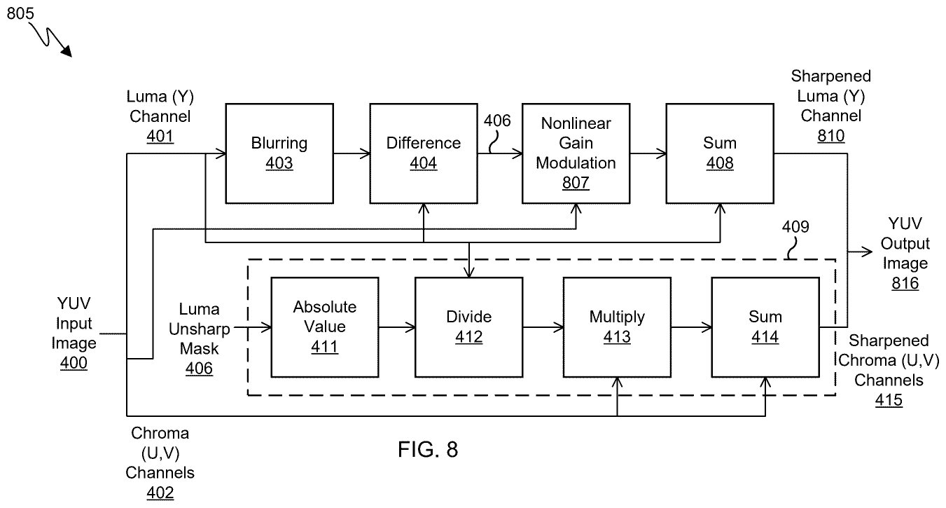

FIG. 8 illustrates an example of unsharp mask image sharpening 805 for image sharpening 305 within the ISP pipeline 300 of FIG. 3 with color-based enhancement modulation in accordance with this disclosure. As with FIG. 6, the operations and inputs/outputs remain the same as in FIG. 4 except for the nonlinear gain modulation operation 807, the sharpened luma image 810, and the sharpened output image 816.

In this example, different enhancement amounts are applied to different areas of differing colors in the input image 400. That is, FIG. 8 illustrates color-based enhancement modulation. In this implementation, the nonlinear gain function utilized by the nonlinear gain modulation operation 807 in FIG. 8 is modified to use another input, which are the chroma channels (U, V) of the input image 400 that represent color. In some cases, this implementation of the nonlinear function may be interpreted as a three-dimensional function, where the enhancement amount is controlled both by the luma unsharp mask 406 and the input chroma image 402. Among other things, this enables the use of lower enhancement amounts in skin areas (identified by typical skin-tone colors) and higher enhancement amounts in foliage areas (also identified by greenish colors) in addition to the above-described luma unsharp mask-based gain modulation.

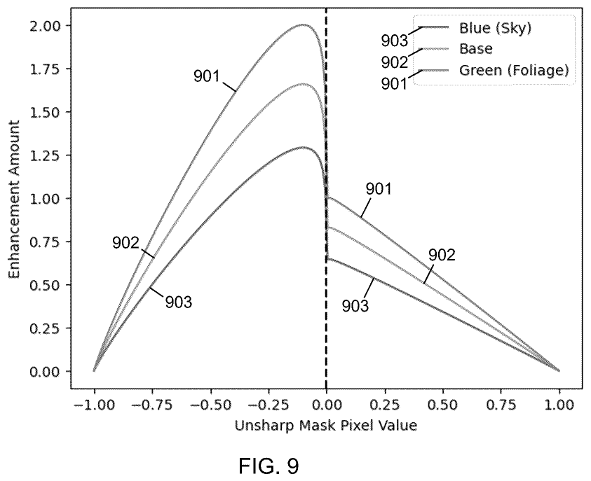

FIG. 9 illustrates an example nonlinear gain function utilized by the nonlinear gain modulation operation 807 in FIG. 8 in accordance with this disclosure. In FIG. 9, gain 901 is applied to the color blue, gain 903 is applied to a base color, and gain 903 is applied to the color green.

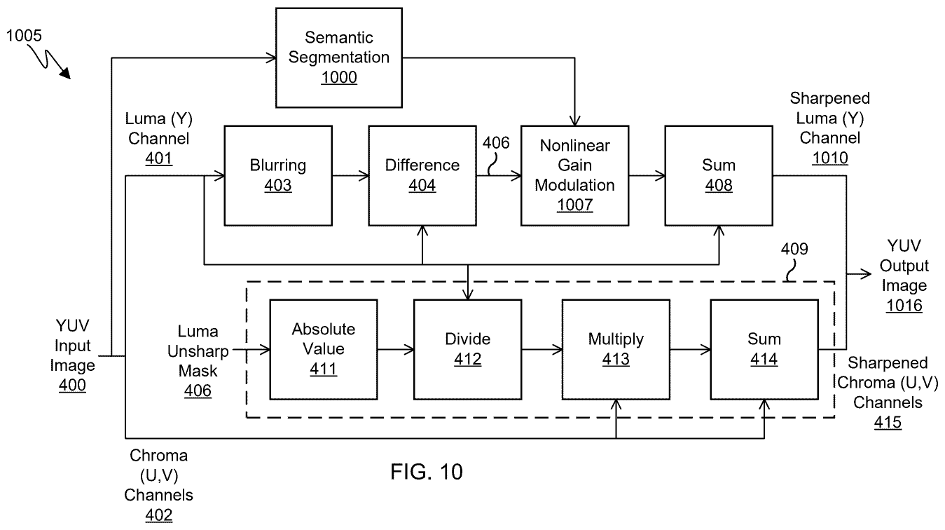

FIG. 10 illustrates an example of unsharp mask image sharpening 1005 for image sharpening 305 within the ISP pipeline 300 of FIG. 3 with semantic information-based enhancement modulation in accordance with this disclosure. As with FIGS. 6 and 8, the operations and inputs/outputs remain the same as in FIG. 4 except for the nonlinear gain modulation operation 1007, the sharpened luma image 1010, and the sharpened output image 1016, as well as the addition of a semantic segmentation operation 1000.

In this example, different enhancement amounts are applied to different semantic areas of the input image 400. That is, FIG. 10 illustrates semantic information-based enhancement modulation. In this implementation, the nonlinear gain function utilized by the nonlinear gain modulation operation 1007 in FIG. 10 is modified to use another input, which is a map output by the semantic segmentation operation 1000 containing semantic class labels for each region of the input image 400 (such as faces, text, objects). In some cases, this implementation of the nonlinear function may be interpreted as a two-dimensional function, where the enhancement amount is controlled both by the luma unsharp mask 406 and the semantic class from the semantic segmentation operation 1000. Among other things, this enables the use of higher enhancement amounts in text areas (such as to improve readability) and lower enhancement amounts in face areas (such as to avoid an “over-processed” look) in addition to the above-described luma unsharp mask-based gain modulation.

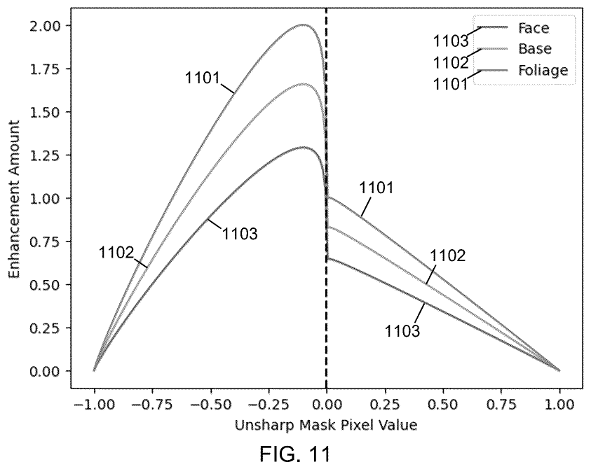

FIG. 11 illustrates an example nonlinear gain function utilized by the nonlinear gain modulation operation 1007 in FIG. 10 in accordance with this disclosure. In FIG. 11, gain 1101 is applied to regions with the semantic class label “face” gain 1102 is applied to regions with the semantic class label “base” and gain 1103 is applied to regions with the semantic class label “foliage”.

As indicated above, FIGS. 4 and 5 relate to an embodiment for image sharpening 305 of FIG. 3 in which the nonlinear gain function is based on the luma unsharp mask only. FIGS. 6 and 7 relate to an embodiment for image sharpening 305 of FIG. 3 in which the nonlinear gain function is based on both the luma unsharp mask and brightness (such as the input luma image). FIGS. 8 and 9 relate to an embodiment for image sharpening 305 of FIG. 3 in which the nonlinear gain function is based on both the luma unsharp mask and color (such as the input chroma image). FIGS. 10 and 11 relate to an embodiment for image sharpening 305 of FIG. 3 in which the nonlinear gain function is based on both the luma unsharp mask and semantic class label (such as “face”, “text”, etc.). Note that the embodiments described in connection with those figures may be employed in any combination of the features disclosed for any individual embodiment. Thus, features described with respect to one embodiment may be used in a different embodiment. That is, any permutation of brightness, color, and/or semantic class may be used in combination with the luma unsharp mask in structuring the nonlinear gain function for image sharpening 305.

Although FIGS. 4 through 11 illustrate examples of unsharp mask image sharpening and examples of nonlinear gain functions, various changes may be made to FIGS. 4 through 11. For example, the specific applications of unsharp mask image sharpening shown here and the specific embodiments of the nonlinear gain functions are for illustration and explanation only and can vary as needed or desired. Also, the use of specific image domains (such as YUV and RGB) are examples only, and image data may be used in any other or additional image domains.

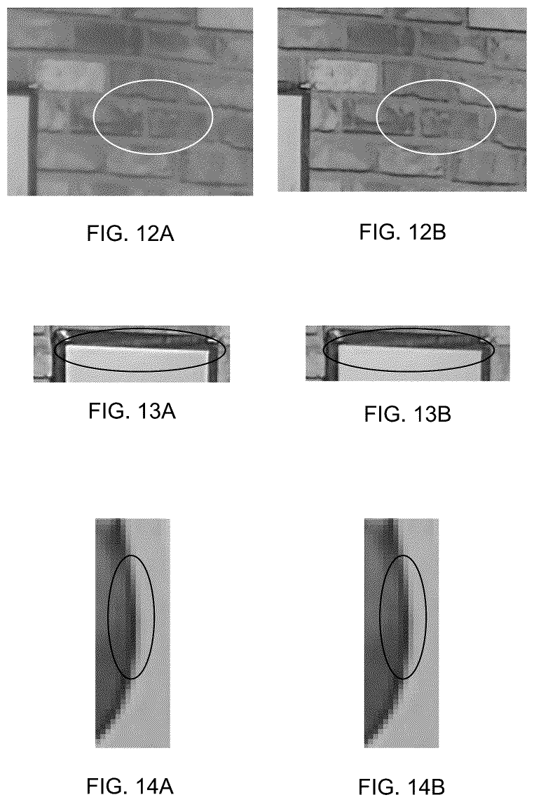

For each of the embodiments discussed above, processed images are visually sharper than input images, where the processed images contain enhanced details and edges. For example, FIGS. 12A and 12B illustrate an example of improved image sharpening within an indicated region in accordance with this disclosure, where details are sharper in accordance with this disclosure (FIG. 12B) than without (FIG. 12A). Also, processed images exhibit reduced halos around edges compared to existing sharpening techniques. For instance, FIGS. 13A and 13B illustrate an example of improved halo control within an indicated region in accordance with this disclosure, where halos are reduced in accordance with this disclosure (FIG. 13B) than without (FIG. 13A). The bright (white) halo region immediately inside the dark-colored frame in FIG. 13A is substantially eliminated in FIG. 13B. In addition, processed images preserve colors in enhanced edges better compared to existing sharpening techniques. FIGS. 14A and 14B illustrate an example of improved edge color (red) preservation within an indicated region in accordance with this disclosure, where edge color preservation is improved in accordance with this disclosure (FIG. 14B) than without (FIG. 14A). Existing image sharpening techniques cause black or brown edges. While not visible in the grayscale rendering of FIGS. 14A-14B, the original color of the boundary depicted in FIGS. 14A-14B is red. In FIG. 14A, sharpened with existing techniques, the boundary color has been converted to dark brown/black. In FIG. 14B, sharpened according to the present disclosure, the boundary color has been substantially retained, as shown by the lighter grayscale rendering of the boundary in FIG. 14B than in FIG. 14A.

Although FIGS. 12A through 14B illustrate examples of improvements obtained using the techniques of this disclosure, various changes may be made to FIGS. 12A through 14B. For example, FIGS. 12A through 14B are meant to illustrate examples of the types of improvements that could be obtained using the techniques of this disclosure. However, the specific improvement or improvements that are obtained can depend on a number of factors, including the specific implementation of the described techniques and the images being processed.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, a first channel of an input image;
generating, using the at least one processing device, an unsharp mask based on the first channel of the input image;
applying, using the at least one processing device, a nonlinear function to pixels of the unsharp mask to obtain a modulated unsharp mask;
combining, using the at least one processing device, the first channel of the input image and the modulated unsharp mask to obtain a first channel of an output image;
sharpening, using the at least one processing device, one or more remaining channels of the input image based on the unsharp mask to obtain one or more remaining channels of the output image; and
combining, using the at least one processing device, the first channel of the output image and the one or more remaining channels of the output image to generate the output image.

2. The method of claim 1, wherein:
the first channel of the input image is a luma channel of the input image; and
the one or more remaining channels of the input image are chroma channels of the input image.

3. The method of claim 1, wherein the nonlinear function is a function of a signed value of the unsharp mask.

4. The method of claim 1, further comprising:
based on the first channel of the input image:
applying a first amount of enhancement with the nonlinear function to areas of the input image having at least a first value for the first channel; and
applying a second amount of enhancement with the nonlinear function to areas of the input image having no more than a second value for the first channel;
wherein the second value is lower than the first value; and
wherein edge halos are reduced during enhancement.

5. The method of claim 1, further comprising:
based on the first channel of the input image:
applying a first amount of enhancement with the nonlinear function to areas of the input image having a first color value; and
applying a second amount of enhancement with the nonlinear function to areas of the input image having a second color value;
wherein edge color is preserved during enhancement.

6. The method of claim 1, further comprising:
performing semantic segmentation of the input image;
applying a first amount of enhancement with the nonlinear function to areas of the input image having a first semantic class label; and
applying a second amount of enhancement with the nonlinear function to areas of the input image having a second semantic class label.

7. The method of claim 6, further comprising:
applying a third amount of enhancement with the nonlinear function to areas of the input image having a third semantic class label.

8. An electronic device comprising:
at least one processing device configured to:
obtain a first channel of an input image;
generate an unsharp mask based on the first channel of the input image;
apply a nonlinear function to pixels of the unsharp mask to obtain a modulated unsharp mask;
combine the first channel of the input image and the modulated unsharp mask to obtain a first channel of an output image;
sharpen one or more remaining channels of the input image based on the unsharp mask to obtain one or more remaining channels of the output image; and
combine the first channel of the output image and the one or more remaining channels of the output image to generate the output image.

9. The electronic device of claim 8, wherein:
the first channel of the input image is a luma channel of the input image; and
the one or more remaining channels of the input image are chroma channels of the input image.

10. The electronic device of claim 8, wherein the nonlinear function is a function of a signed value of the unsharp mask.

11. The electronic device of claim 10, wherein the at least one processing device is further configured to:
based on the first channel of the input image:
apply a first amount of enhancement with the nonlinear function to areas of the input image having at least a first value for the first channel; and
apply a second amount of enhancement with the nonlinear function to areas of the input image having no more than a second value for the first channel;
wherein the second value is lower than the first value; and
wherein edge halos are reduced during enhancement.

12. The electronic device of claim 11, wherein the at least one processing device is further configured to:
based on the first channel of the input image:
apply a first amount of enhancement with the nonlinear function to areas of the input image having a first color value; and
apply a second amount of enhancement with the nonlinear function to areas of the input image having a second color value;
wherein edge color is preserved during enhancement.

13. The electronic device of claim 8, wherein the at least one processing device is further configured to:
perform semantic segmentation of the input image;
apply a first amount of enhancement with the nonlinear function to areas of the input image having a first semantic class label; and
apply a second amount of enhancement with the nonlinear function to areas of the input image having a second semantic class label.

14. The electronic device of claim 13, wherein the at least one processing device is configured to apply a third amount of enhancement with the nonlinear function to areas of the input image having a third semantic class label.

15. A non-transitory machine readable medium containing instructions that when executed cause at least one processor of an electronic device to:
obtain a first channel of an input image;
generate an unsharp mask based on the first channel of the input image;
apply a nonlinear function to pixels of the unsharp mask to obtain a modulated unsharp mask;
combine the first channel of the input image and the modulated unsharp mask to obtain a first channel of an output image;
sharpen one or more remaining channels of the input image based on the unsharp mask to obtain one or more remaining channels of the output image; and
combine the first channel of the output image and the one or more remaining channels of the output image to generate the output image.

16. The non-transitory machine readable medium of claim 15, wherein:
the first channel of the input image is a luma channel of the input image; and
the one or more remaining channels of the input image are chroma channels of the input image.

17. The non-transitory machine readable medium of claim 15, wherein the nonlinear function is a function of a signed value of the unsharp mask.

18. The non-transitory machine readable medium of claim 15, further containing instructions that when executed cause the at least one processor, based on the first channel of the input image, to:
apply a first amount of enhancement with the nonlinear function to areas of the input image having at least a first value for the first channel; and
apply a second amount of enhancement with the nonlinear function to areas of the input image having no more than a second value for the first channel;
wherein the second value is lower than the first value; and
wherein edge halos are reduced during enhancement.

19. The non-transitory machine readable medium of claim 15, further containing instructions that when executed cause the at least one processor, based on the first channel of the input image, to:
apply a first amount of enhancement with the nonlinear function to areas of the input image having a first color value; and
apply a second amount of enhancement with the nonlinear function to areas of the input image having a second color value;
wherein edge color is preserved during enhancement.

20. The non-transitory machine readable medium of claim 15, further containing instructions that when executed cause the at least one processor to:
perform semantic segmentation of the input image;
apply a first amount of enhancement with the nonlinear function to areas of the input image having a first semantic class label;
apply a second amount of enhancement with the nonlinear function to areas of the input image having a second semantic class label; and
apply a third amount of enhancement with the nonlinear function to areas of the input image having a third semantic class label.
